(19) United States
(12) Patent Application Publication
(10) Pub. No.: US 2013/0317853 A1
(43) Pub. Date: Nov. 28, 2013

(54) DEVICE SELECTIVELY STORING AND PRESENTING CRITICAL MEDICAL INFORMATION

(71) Applicant: Atwood International Incorporated, Sharon, CT (US)

(72) Inventor: Anita TIBURZI, Sharon, CT (US)

(21) Appl. No.: 13/900,631

(22) Filed: May 23, 2013

Related U.S. Application Data
(60) Provisional application No. 61/651,622, filed on May 25, 2012.

(51) Int. Cl. G06F 19/00

(52) U.S. Cl. CPC G06F 19/322
USPC 705/3

(57) ABSTRACT

A device for selectively storing and presenting critical medical information about a person who needs immediate medical assistance includes a housing, a memory, a microprocessor and an output member. The microprocessor senses when the information has been requested and presents it through the output member either orally or visually. The device is preferably incorporated into an accessory worn by the patient/wearer for example as a wrist watch, pendant, pin, or other similar accessory.

### RELATED APPLICATIONS

This application claims priority to application Ser. No. 61/651,622 filed May 25, 2012 and incorporated herein by reference in its entirety.

### BACKGROUND OF INVENTION

A. Field of Invention

This invention pertains to a device worn by a person as wrist watch, pin, pendant, etc., that provides critical information about the wearer to a first responder in a case of a medical emergency, or other medical needs.

B. Description of the Prior Art

The number of elderly people in the US, and throughout the world, has been climbing at a steady rate and this has given rise to numerous problems, especially in the field of medicine and elderly care, Moreover, many other people, for example, people of any age who are involved in accidents, may have other medical issues that could incapacitate them, such as allergies, etc., people involved in physical activities such as running, hiking, skiing, rock climbing, frequently need immediate medical attention as well and would like to have their unique critical medical information available. Medical personnel responding to an emergency event have frequent problems determining accurately whether a victim, especially an elderly person, is taking any kind of medication (e.g., Coumadin), has a particular condition (e.g., diabetes), has any prosthetic devices (e.g., a pacemaker), is allergic to any particular drugs, and so on. (This information is referred to herein is critical medical information).

In many instances, a person may get involved in an accident or some other event as a result of which the person may require immediate medical assistance. However in many such instances, a family member or responsible caretaker may not be present to provide this critical medical information. Therefore the first responders may either have to rely on the person to provide the critical medical information; if the person is unable to respond, wait until somebody having relevant knowledge is found (e.g., the person's primary health care provider); or take a chance and administer medical assistance anyway—even without the critical medical information. The first choice is not very advisable, especially for elderly people. The second choice means that immediate procedures that could mean the difference between life and death have to be withheld for up to several hours. The third choice is also undesirable because it may result in interactions with the medicine or prosthetic devices being used or worn by the person.

Thus, there is a need for a device and system that provides a first respondent with the critical medical information he or she requires in order to provide appropriate care to a sick person, a person who required emergency medical attention because of an accident or other events.

### SUMMARY OF THE INVENTION

A device for storing and presenting critical medical information about a person needing immediate medical assistance includes a housing that is preferably incorporated into or disguised as an accessory for the wearer. The accessory may be a wrist watch, a pendant, a pin, or other accessory that incorporates the device. The device includes a data input member receiving the critical medical information, a microprocessor controlling the operation of the device, a memory storing the information and an output member used to selectively present the information. The output member may be a speaker, in which case the information is presented orally, or a screen in which case the information is presented visually. In one embodiment of the invention, a touch screen is provided which presents various pages to a user or wearer. Selecting a page results in the display of certain information, including personal information, critical medical information, etc. Optionally, the medical information is input locally or from a remote location, for example from a pharmacy or a health care provider. Access to the critical medical information may be open or may be controlled by a remote monitoring service.

### BRIEF DESCRIPTION OF THE DRAWINGS

FIG. 1 shows an orthogonal view of a wrist band constructed in accordance with this invention with a closed cover;

FIG. 2 shows an orthogonal view of the wrist band with the cover partially opened;

FIG. 3 shows the screen of the device with various options;

FIGS. 4-13 shows individual screens indicating respective functions or information presented when some of the options of FIG. 3 are selected;

FIG. 14 shows a block diagram of the wrist band of FIG. 1; and

FIG. 15 shows a block diagram of a system for providing information and operating the wrist band.

### DETAILED DESCRIPTION OF THE INVENTION

The present invention consists of a device that provides critical medical information to a first respondent or other critical health care provider. The device can be either incorporated into a piece of jewelry or other accessory, or can be implemented so that it is a standalone apparatus. In a preferred embodiment, the device is a wrist watch. Alternatively, the device can be implemented as, incorporated into a pendant, a brooch or pin, or other accessory to be worn by a person.

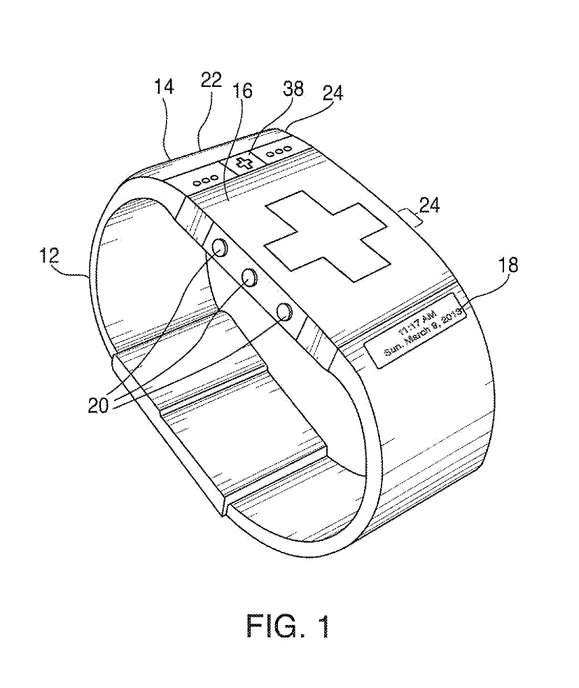

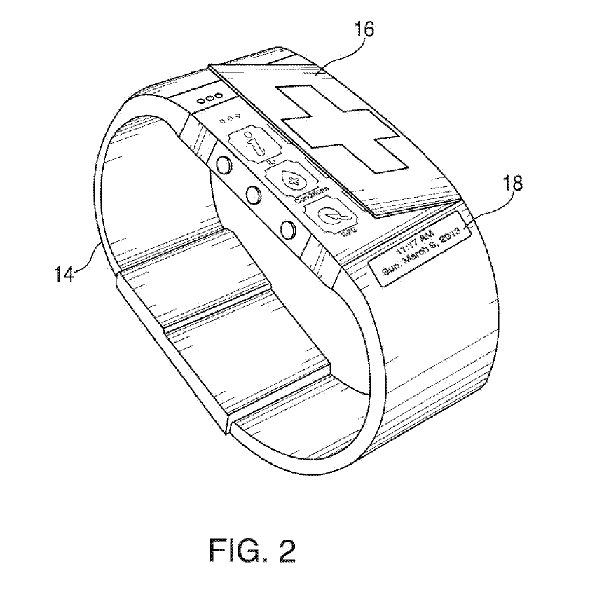

FIG. 1 a device 10 implemented as wrist watch.. The device 10 includes a band 12 sized and shaped to be worn on the wrist of a person. In alternate embodiments, the band may be worn on the ankle. The device is preferably made of a plastic material or coated with a plastic material that is hypoallergenic and is also free of PCBs, PBAs, or Latex.

Importantly, the device includes a main screen 14. Normally, the main screen 14 may be protected by a cover 16 so that it is not visible. Device 10 further includes an auxiliary screen 18. Several buttons 20 are provided to operate the device, as discussed in more details below.. Device 10 further includes speakers 22, microphone 24 and an input/output USB port 26. The face of device 10 may also be provided with a prominent emergency button 38. A hidden switch or a light sensor built into the watch senses when the cover is closed and shuts off the screen 14 to preserve power. The auxiliary screen 18 may be an LCD screen or other screen that draws only a small amount of power and may be always on to show the current time, date, etc.

The screen 18 is a standard screen and is used to present to the wearer the time of the day, the date, etc. The screen 14 is a touch sensitive screen so that virtual buttons can be presented on the screen and various functions of the device 10 are initiated by touching a respective section of the screen 14. Both screens 14 and 18 can be made of a shatter-proof and shatter-resistant material such as glass.

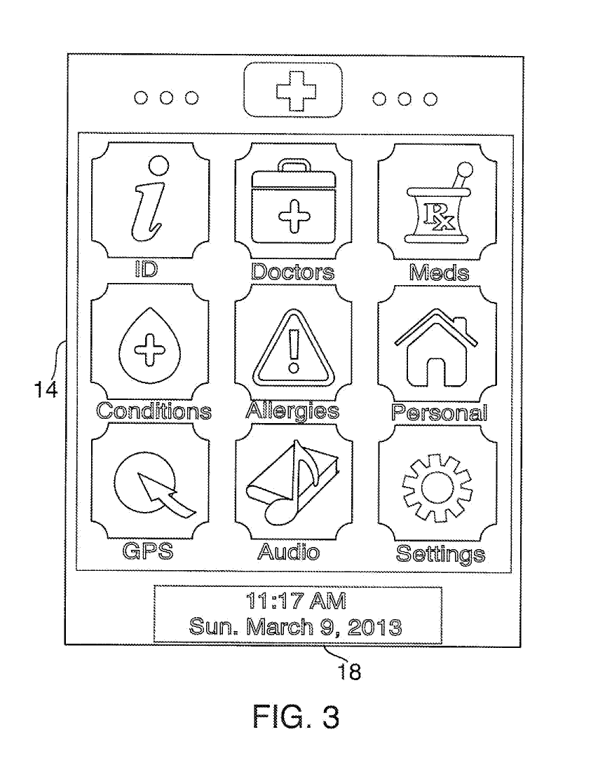

For example, as shown in FIG. 3, the device can provide with several different classes of information and/or functions such as ID, doctors, medications (Meds), conditions, allergies, personal, GPS, audio and settings. More or less classes of information or functions can be provided and respective icon can be presented on the screen 14 using a single page or several pages.

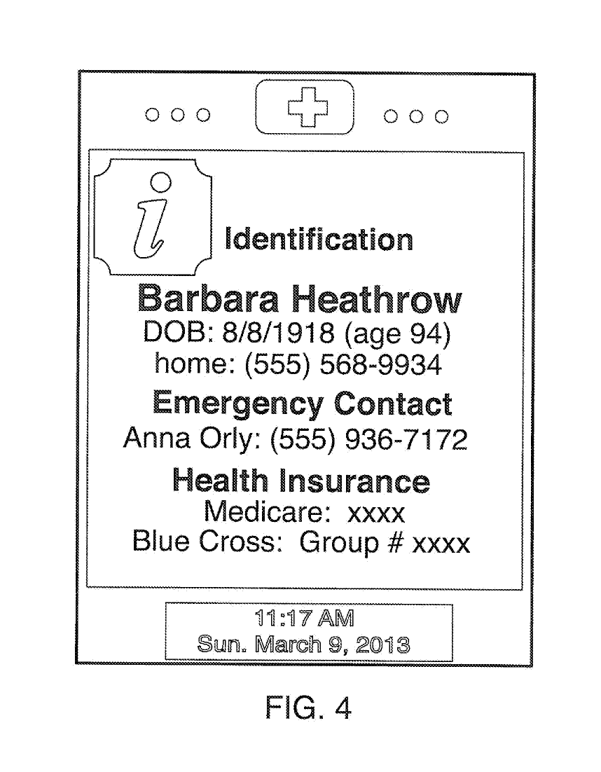

For example, when the ID icon is selected, information about the wearer is provided, as shown in FIG. 4, including the wearer's name, birthday, telephone number, emergency contact information, health insurance information, etc.

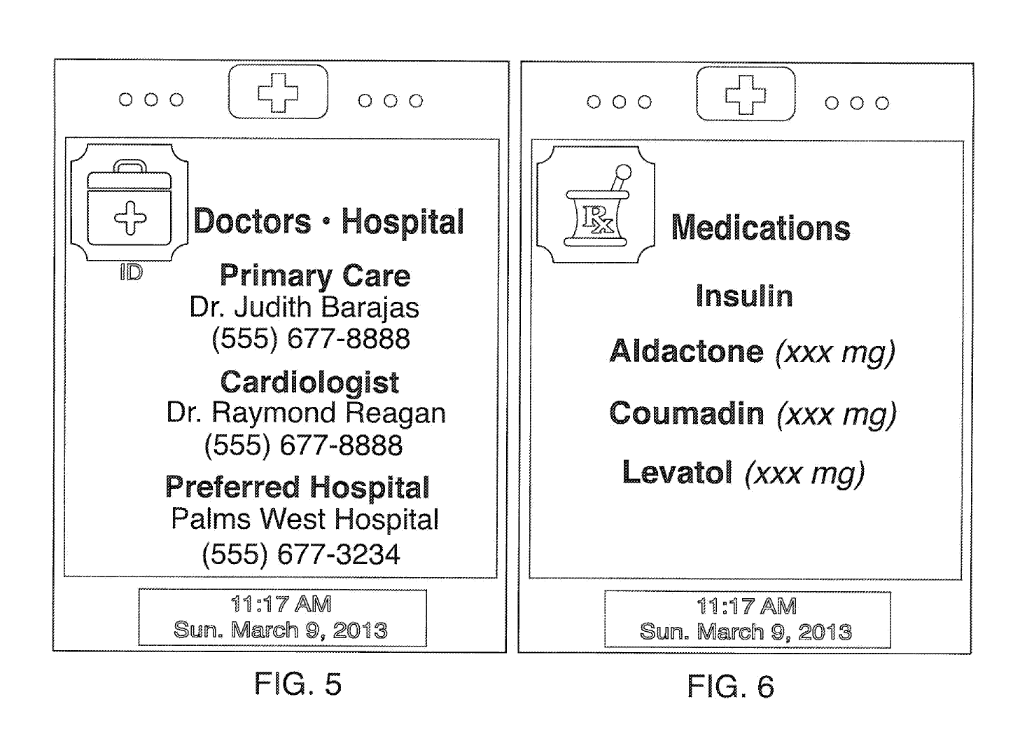

The DOCTORS icon leads (FIG. 5) to a list of doctors and the hospital that are caring for the wearer. The MEDS icon leads (FIG. 6) to a list of medications that have been subscribed to the patient with respective dosages.

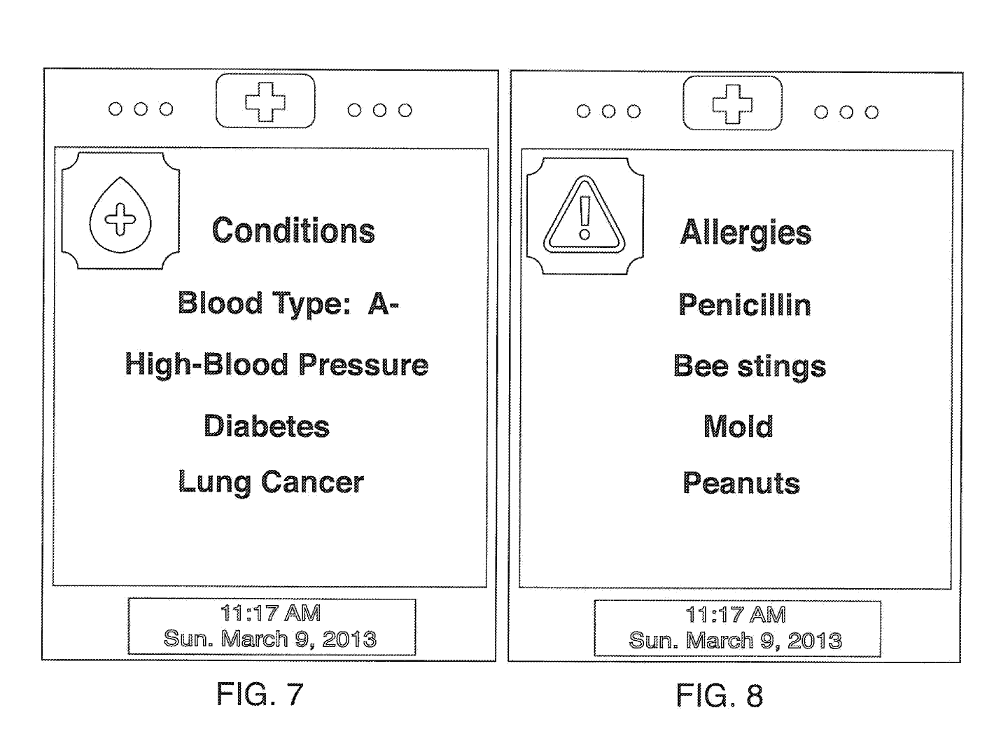

The CONDITIONS icon (FIG. 7) and the allergies (FIG. 8) provide respective lists of conditions/illnesses or allergies that the wearer has.

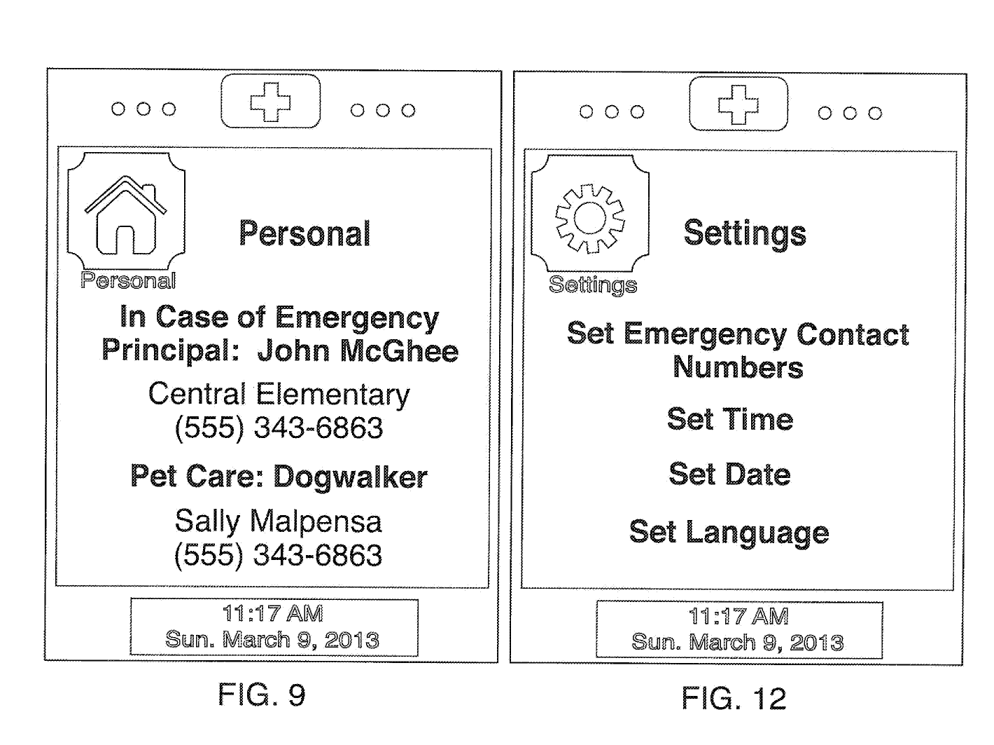

The PERSONAL icon (FIG. 9) is used to store other information that is not necessarily medical information as shown.

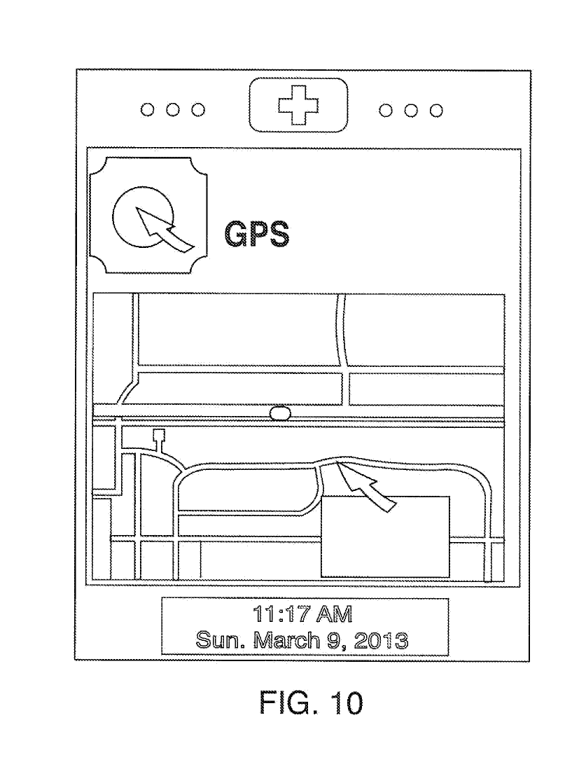

The GPS icon (FIG. 10) activates a GPS function that can provide the current location of the wearer not only on screen 14 but also to a remote location on demand.

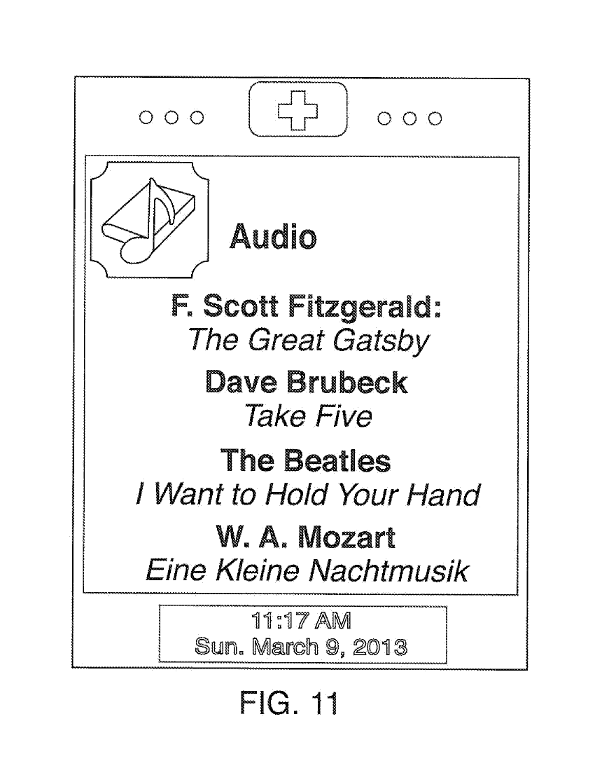

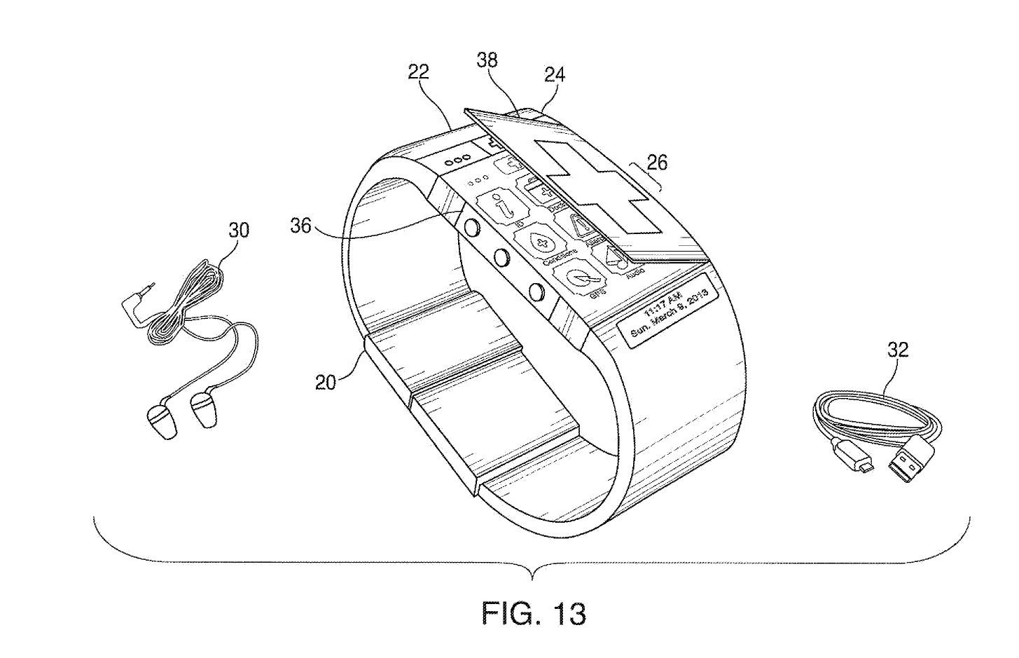

FIG. 11 illustrates a personal mode of operation for the device 10. In this mode, the wearer can use the device 10 as an I-Pod type player that can play prerecorded music and/or visual content.

FIG. 12 illustrates a setting mode for the device in which a wearer or other person can enter the medical critical information presented in other modes and other operational parameters, such as the current date, time, set a language of choice, etc.

The device 10 can be made self-sufficient and used as is since it can have its own speakers 22 and microphone 24, but can be provided with several accessories as well, including headphones 30 connectable to the device through audio port 36, a USB cable 34 (for charging through the port 26, etc.

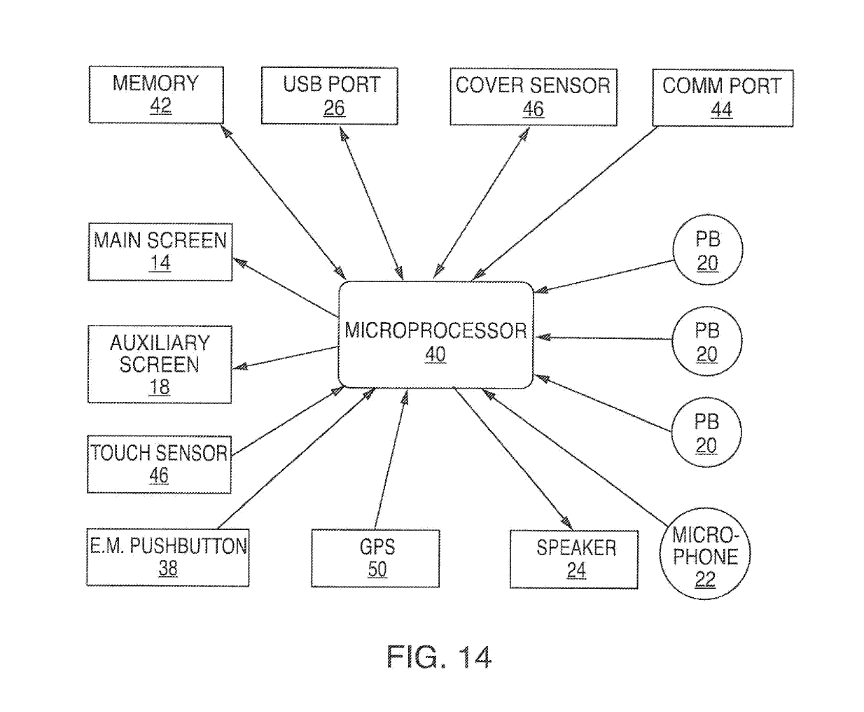

FIG. 14 shows a block diagram with several electronic modules used in the device 10. These modules could be combined however they are shown as discrete components for the sake of simplicity. Device 10 thus preferably includes a microprocessor 40, a memory 42, a remote communication port 46. The microprocessor 40 is further in communication with the control buttons 20, emergency button 38, USB port 26, a cover sensor 48, touch sensor 44, and also drives screens 14 and 18.

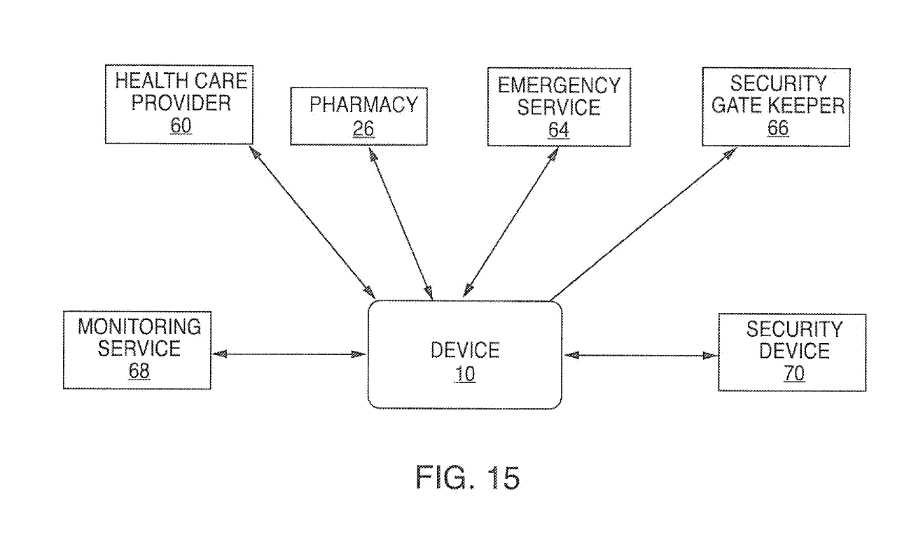

In one embodiment, device 10 operates independently and does not communicate electronically with other entities. In another embodiment, the device 10 communicates with other entities through communication port 44. In this latter embodiment, the device 10 can communicate with the primary health care provider 60 (see FIG. 15) that may be a physician, a hospital, a service monitoring several patients, etc. The device can also communicate with a pharmacy 62, an emergency service 64, a security gate keeper, etc.

The operation of the device 10 is now described in conjunction with the drawings. Initially, the medical and personal information is loaded into the memory 42 either locally through the USB port 26 or remotely through communication port 44. This information includes personal information as well as critical medical information as discussed above. The information originates from the patient, the health care provider 60 or the pharmacy 62. Preferably, as the status of the patient changes, the information in memory 42 is updated accordingly. For example, a list of drugs being taken by the patient is updated so that it is always current.

In one embodiment of the invention, at least some of the information is maintained not in the device 10 but at a remote location such as the monitoring service 68, and presented to the device 10 only when requested.

Once the information is provided to, and stored by the device 10, the patient can start wearing the device. As discussed above, the device 10 can be worn openly as a wrist watch, pendant or pin, or can be made innocuous so that it is not apparent that the wearer has it. The device 10 is initially in a normal mode in which the cover 16 is closed, main screen 14 is off or at least invisible, and auxiliary screen 18 is on all the time to show the current time, date, etc., like other wrist watches. Alternatively, the auxiliary screen 18 can be activated to show the current date or time by activating one of the pushbuttons 20. In extreme situations, and assuming the wearer agrees to it, the GPS (or other location detection means) detects the current position of the patient and sends it to a remote location, such as the monitoring service 68. Alternatively, the wearer gets lost and wants to know his present location. He then opens the cover 16, is presented with an initial selection of virtual buttons as shown in FIG. 3, selects the GPS button and is then presented with a map showing his current position (See FIG. 10). The wearer can also take advantage of other functions of the device, such as selecting and listening to a song by selecting the audio screen (FIG. 11)

The main function of device 10 is to provide information specific to the wearer, and, more specifically, critical medical information, Such information may be needed in a number of different scenarios. In one scenario, the wearer falls down, either at home, on the street, or some other location, and gets hurt. She is still conscious and presses the EM button 38. In response, the microprocessor 40 sends out an alert to one or more predesignated entities, such as the monitoring service 68, the health care provider 60, the emergency service 64 and/or relative or caretaker for the wearer. The parties to be contacted are designated originally and can be viewed from the setting screen (FIG. 12). The communication can take place directly via cell phone system, or indirectly through an intermediate device(not shown) and a landline telephone, or other similar means.

The alert could be simply an emergency message indicating in its simplest form that the wearer needs help. Voice communication is then established between the wearer and an attendant at the emergency or monitoring service. Questions can be asked through speaker 22 and the wearer can answer through microphone 24. In a more sophisticated mode, the alert message or a subsequent message is sent by the microprocessor indicating the identity of the wearer, his or her special conditions that should be known by the emergency service, and his or her location as indicated by the GPS. The attendant can make an appropriate determination of what needs to be done to help the wearer and send out the appropriate personnel to provide assistance.

In another scenario, the wearer falls down, gets involved in an accident, or something else happens that incapacitates the wearer. In this case, the a first responder arrives on the scene to assist. He locates the device 10 on the wearer, opens the cover 16 and is then presented with various choices, as shown in FIG. 3. He can select whatever information he needs about the patient that will enable him to provide immediate care. For example, if the patient appears to have a cardiac arrest, the first responder can select the CONDITIONS button and be presented with information (see FIG. 7) indicating severe illnesses, an implanted defibrillator, etc.

Alternatively, the first responder determines that the wearer should be administered a drug, orally or by injection. He can select the MEDS and the ALLERGIES buttons and be provided with a list of medicines prescribed to the wearer and any known allergies.

Next, the first responder decides that the wearer should be hospitalized. The wearer is placed in an ambulance and on the way to the hospital, the first responder, or some other personnel can read off and provide the hospital with the wearer's name, insurance, primary health care provider, specialists, next of kin, etc. The hospital may also like to know and the first responder can provide information such as the drugs being prescribed, if the wearer has any allergies, etc. All this information is readily and quickly available from or through the device.

Preferably the information described above is available to the wearer or the first responder without taking any additional steps. However, some of this information can be very sensitive and the wearer may want to protect its unauthorized dissemination. Under these conditions, access may be restricted, for example by requiring that the first responder contact the gate keeper 66, and request the sensitive information. The gate keeper may then provide the first responder with a code to unlock either the device or the sensitive information. Alternatively, the gatekeeper may send a code directly to the device to unlock either the whole device of the sensitive information. Alternatively, the information may be encrypted and made available to the first responder after a decryption key is provided by the gate keeper 66.

In one embodiment, the device 10 is locked so that either all the information or the critical medical information are locked and are released only when a security device 10 (e.g. an FM or RF transmitter) is activated by the first responder.

Finally, as discussed above, some or all the information is stored remotely to protect the privacy of the wearer and may be sent to the device on demand and need to know basis.

Obviously numerous modifications may be made to this invention without departing from its scope as defined in the appended claims.

I claim:

1. A device incorporated into an clothing accessory to be worn by a person comprising:
a housing supporting a data input member arranged and constructed to receive critical medical information about the person wearing the device;
a processor disposed in said housing and configured to control the operation of the device;
a memory disposed in said housing and storing the critical medical information; and
an output member configured to selectively retrieve the critical health information from the memory and present said information.

2. The device of claim 1 wherein said output member is a speaker presenting said information orally.

3. The device of claim 1 wherein said output member is a screen presenting said information visually.

4. The device of claim 1 wherein said housing is adapted to be incorporated into one of a wristwatch, a pendant and a pin.

5. The device of claim 1 wherein said data input member includes a socket arranged and constructed to connect to a cable to receive the critical medical information and store it in said memory.

6. The device of claim 1 wherein said data input member is a data port arranged and constructed to receive said critical medical data from a remote location.

7. The device of claim 1 further comprising a pushbutton supported on said housing wherein said critical medical information is presented in response to an activation of said push button.

8. A device for providing selectively critical medical information about a wearer, said device comprising:
a housing structured and arranged to be incorporated into an accessory item worn by a person;
a data input member supported by the housing and adapted to receive critical medical information about the wearer from the wearer's primary health care provider;
a memory disposed in the housing and storing said critical medical information, and personal information related to the wearer;
a microprocessor disposed in the housing and adapted to control the operation of the device;
a main screen disposed on the housing and adapted to select said critical medical information from said memory in response to commands from the microprocessor; and
an emergency button disposed on said housing;
wherein activation of the emergency button is sensed by the microprocessor and in response said microprocessor immediately causes said critical medical information to be retrieved from said memory and presented on said screen.

9. The device of claim 8 further comprising a second screen presenting a current time, said second screen being supported on said housing.

10. The device of claim 8 further comprising a cover selectively covering said main screen.

11. The device of claim 10 wherein said microprocessor senses a position of said cover and disables said main screen when said cover is closed.

12. The device of claim 11 further comprising a touch element disposed on said main screen, said microprocessor being adapted to present a plurality of virtual buttons on said main screen under said touch element, in response to said cover being opened.

13. The device of claim 12 wherein said memory includes sets of data forming said critical medical information, each set of data being associated with one of said virtual buttons, wherein said microprocessor is adapted to sense when one of said virtual buttons is selected by a person by touching a respective portion of said touch element, and to present the respective set of data on the main screen.

14. The device of claim 8 further comprising a GPS element selectively generating a GPS output.

15. The device of claim 14 wherein said microprocessor is configured to selectively present a current position of the device based on said GPS output on said main screen

16. The device of claim 14 wherein said microprocessor is configured to selectively transmit a current position of the device based on said GPS output to a remote location.

17. The device of claim 8 wherein said memory includes several sets of data defining said critical medical information, said sets of data including one of allergy information defining allergies associated with the wearer of the device, drug information defining what drugs have been prescribed for the wearer; special condition information defining specific illnesses of the wearer; said sets of data including personal information associated with the wearer; and health care provider information associated with health care providers for the wearer.

18. A method of obtaining critical medical information about a patient who needs immediate medical attention, said patient wearing an accessory incorporating a device including a housing, a memory holding said critical medical information and an emergency button disposed on said housing, said method comprising the steps of:
automatically sensing within said device that the emergency button has been activated;
in response to said activation, obtaining said critical medical information from the memory; and
presenting said critical medical information

19. The method of claim 18 wherein said critical medical information is presented orally.

20. The method of claim 18 wherein said critical medical information is presented visually.
